(19) United States
(12) Patent Application Publication
(10) Pub. No.: US 2026/0360964 A1
(43) Pub. Date: Nov. 12, 2026

(54) ANTENNA APPARATUS, SCREEN PROJECTOR, AND TERMINAL DEVICE

(71) Applicant: SHENZHEN TCL DIGITAL TECHNOLOGY LTD., Shenzhen (CN)

(72) Inventors: Liuzhong YIN, Shenzhen (CN); Chengwei WU, Shenzhen (CN)

(73) Assignee: SHENZHEN TCL DIGITAL TECHNOLOGY LTD., Shenzhen (CN)

(21) Appl. No.: 19/131,870

(22) PCT Filed: Aug. 30, 2023
(86) PCT No.: PCT/CN2023/115671

§ 371 Date: May 21, 2025

(30) Foreign Application Priority Data
Nov. 25, 2022 (CN) 202211493986.1

(51) Int. Cl. H01Q 1/22; H01Q 5/20; H01Q 5/30; H01Q 5/50; H01Q 9/04

(52) U.S. Cl. CPC H01Q 1/22; H01Q 5/20; H01Q 5/30; H01Q 5/50; H01Q 9/0414

(57) ABSTRACT

The present application discloses an antenna apparatus, a screen projector, and a terminal device. The antenna apparatus comprises: a PCB comprising a substrate layer and a metal layer which are stacked, the metal layer comprising a first region and a second region, and the first region forming a radiator; and a metal plate spaced apart from the PCB and located on one side of the substrate layer, the metal plate forming a system ground, and the metal plate being electrically connected to the second region, so that the second region is grounded.

This application claims priority to Chinese Application No. 202211493986.1 filed Nov. 25, 2022, and entitle with “ANTENNA APPARATUS, SCREEN PROJECTOR, AND TERMINAL DEVICE”, the contents of which are incorporated herein by reference in their entirety.

### FIELD OF THE INVENTION

The present disclosure relates to the field of antenna technology, and in particular to an antenna device, a screen projector and a terminal device.

### BACKGROUND

There are many common ways to set up antennas in electronic devices. One is to set up the antenna directly on the printed circuit board (PCB), and the other is to set up the antenna on a plastic bracket on the PCB.

### Technical Problem

For the antenna with a metal plate under the PCB, if the antenna is directly set on the PCB, the PCB and the metal plate will form a capacitor structure, which will affect the radiation performance of the antenna. If the antenna surface is raised by setting a plastic bracket whose electromagnetic influence can be basically ignored, the structural requirements of the low profile of the antenna cannot be met.

### Technical Solution

The purpose of the present disclosure is to provide an antenna device, a screen projector and a terminal device. In the antenna device, the metal layer in the PCB is electrically connected to the metal plate, thereby effectively avoiding the influence of the metal plate on the antenna radiation performance, while also being able to achieve the low-profile structural requirements.

In order to achieve the above objectives, the present disclosure adopts the following technical solutions:

An embodiment of the present disclosure provides an antenna device. The antenna device includes:
a printed circuit board (PCB), comprising a substrate layer and a metal layer stacked, wherein the metal layer comprises a first area and a second area, and the first area forms a radiator;
a metal plate, spaced apart from the PCB and located on one side of the substrate layer, the metal plate forms a system ground. The metal plate is electrically connected to the second area to ground the second area.

In some embodiments, the metal plate is electrically connected to the second area via a conductive member; the substrate layer is provided with a through hole, one end of the conductive member is connected to the metal plate, and the other end of the conductive member passes through the through hole and abuts against the second area.

In some embodiments, the metal plate is electrically connected to the second area through a conductive member; the substrate layer is provided with a via, a wall of the via is covered with a conductive layer, and the conductive member is connected to the second area through the via.

In some embodiments, the conductive member is a conductive foam, a metal spring or a metal ejector pin.

In some embodiments, the radiator comprises:
a first radiating portion, connected to a feed source to feed an excitation signal;
a second radiating portion, electromagnetically coupled to the first radiating portion.

In some embodiments, the first radiating portion comprises:
a low-frequency radiation branch, one end of low-frequency radiation branch being connected to the feed source, and the other end of low-frequency radiation branch forming a free end;
a first high-frequency radiation branch, one end of the first high-frequency radiation branch being connected to the low-frequency radiation branch, and the other end of the first high-frequency radiation branch being electrically connected to the second area to achieve grounding.

In some embodiments, the second radiation portion comprises a second high-frequency radiation branch, one end of the second high-frequency radiation branch is connected to the second area, and the other end of the second high-frequency radiation branch forms a free end.

In some embodiments, the low-frequency radiation branch comprises a first part and a second part, one end of the first part is used to connect to a feed source, and the other end of the first part is connected to the second part via a loading inductor.

In some embodiments, the second part is bent.

In some embodiments, a frequency range of the low-frequency radiation branch is 2.4 GHz to 2.5 GHz; a frequency range of the first high-frequency radiation branch and the second high-frequency radiation branch is 5.1 GHz to 5.9 GHz.

In some embodiments, the antenna device further comprises a feed source disposed on the PCB and connected to the radiator through a microstrip line.

Another embodiment of the present disclosure provides a screen projector which comprises a casing and an antenna device arranged in the casing. The antenna device comprises:
a printed circuit board (PCB), comprising a substrate layer and a metal layer stacked, wherein the metal layer comprises a first area and a second area, and the first area forms a radiator;
a metal plate, spaced apart from the PCB and located on one side of the substrate layer, the metal plate forms a system ground. The metal plate is electrically connected to the second area to ground the second area.

In some embodiments, the metal plate is electrically connected to the second area via a conductive member; the substrate layer is provided with a through hole, one end of the conductive member is connected to the metal plate, and the other end of the conductive member passes through the through hole and abuts against the second area.

In some embodiments, the metal plate is electrically connected to the second area through a conductive member; the substrate layer is provided with a via, a wall of the via is covered with a conductive layer, and the conductive member is connected to the second area through the via.

In some embodiments, the conductive member is a conductive foam, a metal spring or a metal ejector pin.

In some embodiments, the radiator comprises:
a first radiating portion, connected to a feed source to feed an excitation signal;
a second radiating portion, electromagnetically coupled to the first radiating portion.

Another embodiment of the present disclosure provides a terminal device, which comprises an antenna device. The antenna device comprises:
a printed circuit board (PCB), comprising a substrate layer and a metal layer stacked, wherein the metal layer comprises a first area and a second area, and the first area forms a radiator;
a metal plate, spaced apart from the PCB and located on one side of the substrate layer, the metal plate forms a system ground. The metal plate is electrically connected to the second area to ground the second area.

In some embodiments, the metal plate is electrically connected to the second area via a conductive member; the substrate layer is provided with a through hole, one end of the conductive member is connected to the metal plate, and the other end of the conductive member passes through the through hole and abuts against the second area.

In some embodiments, the metal plate is electrically connected to the second area through a conductive member; the substrate layer is provided with a via, a wall of the via is covered with a conductive layer, and the conductive member is connected to the second area through the via.

In some embodiments, the conductive member is a conductive foam, a metal spring or a metal ejector pin.

### Advantageous Effect

The present disclosure provides an antenna device, a screen projector and a terminal device. The antenna device includes a PCB and a metal plate. The PCB includes a substrate layer and a metal layer stacked in layers. The metal layer includes a first area and a second area. The first area forms a radiator. The metal plate is spaced apart from the PCB and is located on one side of the substrate layer. The metal plate forms a system ground. The metal plate is electrically connected to the second area to ground the second area, so as to avoid the metal plate and the PCB forming a capacitor structure, thereby improving the radiation performance while achieving a low profile of the antenna device.

### BRIEF DESCRIPTION OF THE DRAWINGS

In order to more clearly illustrate the technical solutions in the embodiments of the present disclosure, the drawings required to be used in the description of the embodiments will be briefly introduced below, and it is obvious that the drawings described below are only some embodiments of the present disclosure, and for those skilled in the art, other drawings can be acquired according to these drawings without creative labor.

FIG. 1 is a schematic diagram of an antenna device according to an embodiment of the present disclosure.

FIG. 2 is a schematic diagram of a first area and a second area in an antenna device according to an embodiment of the present disclosure.

FIG. 3 is a schematic diagram of a through hole in a substrate layer in the antenna device according to an embodiment of the present disclosure.

FIG. 4 is a schematic diagram of a radiator in the antenna device according to an embodiment of the present disclosure.

FIG. 5 is a standing wave ratio curve diagram of the antenna device according to an embodiment of the present disclosure.

FIG. 6 is a radiation pattern of the antenna device according to an embodiment of the present disclosure.

FIGS. 7 and 8 are schematic diagrams of the screen projector of the present disclosure.

### DETAILED DESCRIPTION

The purpose of the present disclosure is to provide an antenna device, a screen projector and a terminal device, wherein the antenna device effectively avoids the influence of the metal plate on the antenna radiation performance by electrically connecting the metal layer in the PCB with the metal plate, while also being able to achieve the low-profile structural requirements.

In order to make the purpose, technical solution and effect of the present disclosure clearer and more specific, the present disclosure is further described in detail with reference to the accompanying drawings and examples. It should be understood that the specific examples described here are only used to explain the present disclosure and are not used to limit the present disclosure.

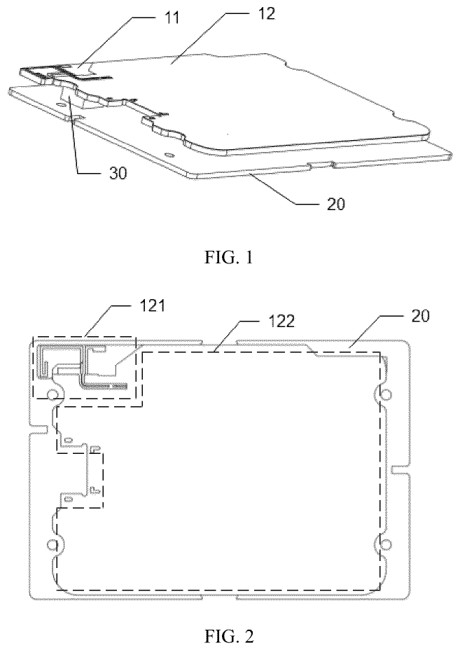

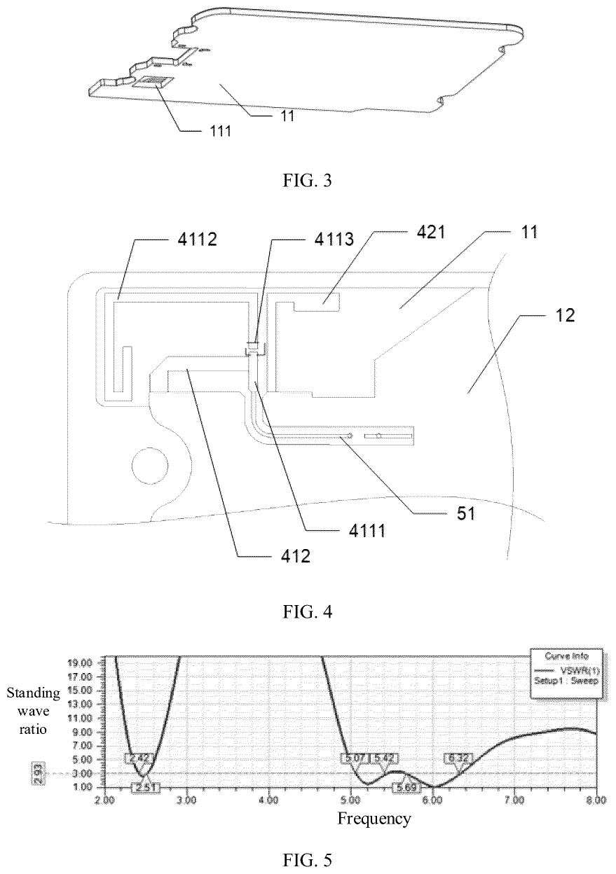

Please refer to FIGS. 1, 2 and 3. The present disclosure provides an antenna device, including a printed circuit board (PCB) board and a metal plate 20. The PCB includes a substrate layer 11 and a metal layer 12 that are stacked. The metal layer 12 includes a first area 121 and a second area 122. The metal of the metal layer 12 can be copper. The metal layer 12 covers the substrate layer 11, and the first area 121 forms a radiator. The metal plate 20 is spaced apart from the PCB and is located on one side of the substrate layer 11. The metal plate 20 functions as a system ground. The metal plate 20 is electrically connected to the second area 122 to ground the second area 122. The second area 122 serves as the ground of the radiator. The second area 122 in the PCB is connected to the system ground. While directly arranging the antenna on the PCB to achieve a low profile, it can avoid the metal plate 20 and the PCB from forming a capacitor structure, thereby improving the radiation performance of the antenna device.

In one embodiment of the present disclosure, the metal plate 20 is electrically connected to the second area 122 through the conductive member 30. The substrate layer 11 is provided with a through hole 111. One end of the conductive member 30 is connected to the metal plate 20, and the other end of the conductive member 30 passes through the through hole 111 and abuts against the second area 122, so that the second area 122 is electrically connected to the metal plate 20.

In another embodiment of the present disclosure, the metal plate 20 is electrically connected to the second area 122 through the conductive member 30. The substrate layer 11 is provided with a via. A hole wall of the via is covered with a conductive layer, and the conductive member 30 is connected to the second area 122 through the via. In this embodiment, the conductive member 30 is indirectly electrically connected to the second area 122 through the conductive hole of the substrate layer 11, ensuring that the second area 122 is grounded, avoiding a formation of a capacitor structure between the metal plate 20 and the PCB, overcoming the capacitive energy storage effect between the PCB and the metal plate 20 where the radiator is located, so as to improve the radiation efficiency of the radiator.

It should be noted that the conductive member 30 in the present disclosure can be but not limited to a conductive foam, a metal spring or a metal ejector pin. In the present disclosure, by setting the conductive member 30 between the PCB and the metal plate 20, the ground of the radiator in the PCB is connected to the system ground, thereby avoiding the formation of a capacitor structure between the metal plate 20 and the PCB, overcoming the capacitive energy storage effect between the PCB where the radiator is located and the metal plate 20, so as to improve the radiation efficiency of the radiator.

In one embodiment of the present disclosure, the metal layer 12 and the substrate layer 11 in the present disclosure are stacked. The metal layer 12 includes a first area 121 and a second area 122. The second area 122 forms a radiator. In order to ensure the grounding effect, the conductive member 30 can be disposed between the metal plate 20 and the PCB close to the radiator to ensure that the radiator can obtain the best radiation effect.

In some embodiments, referring to FIG. 4, the radiator includes a first radiating portion and a second radiating portion. The first radiating portion connecting to a feed source is used to feed an excitation signal. The second radiating portion is electromagnetically coupled to the first radiating portion, and the second radiating portion is also connected to the second area 122 to achieve grounding.

In some embodiments, the first radiation portion includes a low-frequency radiation branch and a first high-frequency radiation branch 412. One end of the low-frequency radiation branch connects to the feed source, and the other end of the low-frequency radiation branch forms a free end. One end of the first high-frequency radiation branch 412 connects to the low-frequency radiation branch, and the other end of the first high-frequency radiation branch 412 is electrically connected to the second area 122 to achieve grounding, thereby the first high-frequency radiation branch 412 is short-circuited.

In some embodiments, the second radiation portion includes a second high-frequency radiation branch 421. One end of the second high-frequency radiation branch 421 is connected to the second area 122, and the other end of the second high-frequency radiation branch 421 forms a free end. The second high-frequency radiation branch 421 and the first high-frequency radiation branch 412 form a high-frequency resonance part of the radiator. The second high-frequency radiation branch 421, as a parasitic branch, constitutes a high-frequency resonance part with the first high-frequency radiation branch 412, which can effectively expand the bandwidth. Specifically, FIG. 5 illustrates a standing wave ratio curve of the antenna device of the present disclosure. According to the standing wave ratio curve, the radiation frequency of the high-frequency resonance part formed by the first high-frequency radiation branch 412 and the second high-frequency radiation branch 421 in this embodiment is 5.1 GHZ~5.9 GHz.

In some embodiments, the low-frequency radiation branch includes a first part 4111 and a second part 4112. One end of the first part 4111 connects to the feed source, and the other end of the first part 4111 is connected to the second part 4112 via a loading inductor 4113. The low-frequency radiation branch is longer than the high-frequency radiation branch. In this embodiment, by setting a loading inductor 4113, the length of the low-frequency radiation branch can be equivalently extended, ensuring that the low-frequency radiation branch meets the performance requirements within a limited space, reducing the area occupied by the PCB, and thus facilitating the miniaturization of the antenna device.

In some embodiments, in order to reduce the area occupied by the low-frequency radiation branch, the second part 4112 in the low-frequency radiation branch can not only meet the required length of the low-frequency radiation branch, but also reduce the area occupied on the PCB, thereby realizing the miniaturized structure of the antenna device. As illustrated in the standing wave ratio curve of FIG. 5, it can be seen that the radiation frequency range of the low-frequency radiation branch in this embodiment is 2.4 GHZ~2.5 GHz.

In some embodiments, the antenna device further includes a feed source, which is disposed on a PCB and connected to a radiator via a microstrip line. The feed source may be a wifi module. Both sides of the microstrip line are connected to the second area 122 of the metal layer 12, which can effectively shield interference signals and ensure the stability of the excitation signal transmission, thereby optimizing the radiation performance of the antenna device.

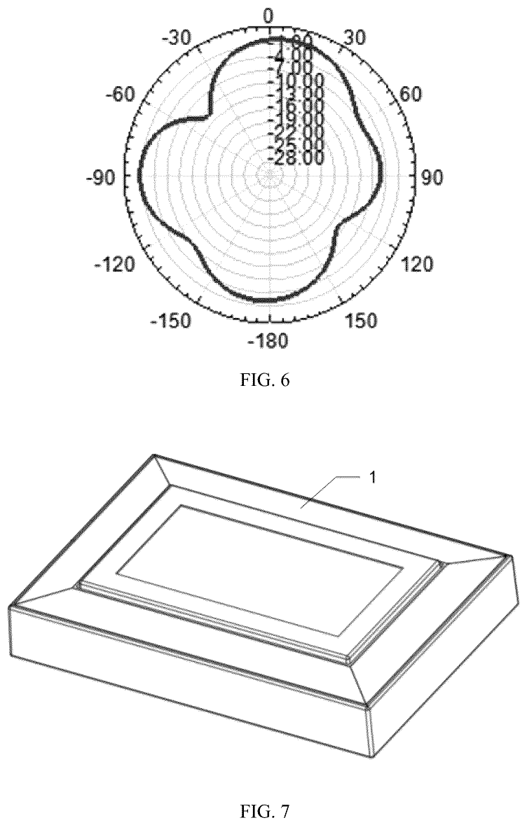

The antenna device in the present disclosure electrically connects the metal layer in the PCB with the metal plate, effectively avoiding the influence of the metal plate on the antenna radiation performance, ensuring that the antenna device has better directivity. Specifically, FIG. 6 illustrates a radiation pattern of the antenna device in the present disclosure, and it can be seen from FIG. 6 that the radiation direction of the antenna device in the present disclosure is uniform.

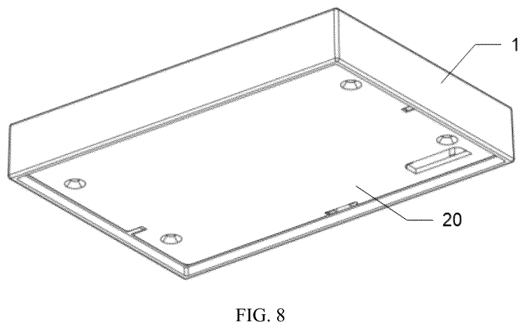

Further, please refer to FIG. 7 and FIG. 8. The present disclosure also provides a screen projector having a casing 1. The antenna device is arranged inside the casing 1. In this embodiment, as shown in FIG. 8, the casing 1 is semi-enclosed. That is, the metal plate 20 serves as a bottom of the casing 1. Since the antenna device is described in detail above, it will not be repeated here.

Furthermore, the present disclosure also provides a terminal device. The terminal device includes the antenna device. Since the antenna device is described in detail above, it will not be repeated here.

In summary, the present disclosure provides an antenna device, a screen projector and a terminal device. The antenna device includes a PCB and a metal plate. The PCB includes a substrate layer and a metal layer stacked in layers. The metal layer includes a first area and a second area. The first area forms a radiator. The metal plate is spaced apart from the PCB and is located on one side of the substrate layer. The metal plate forms a system ground. The metal plate is electrically connected to the second area to ground the second area, so as to avoid the metal plate and the PCB forming a capacitor structure, thereby improving the radiation performance while achieving a low profile of the antenna device.

It is understandable that those skilled in the art can make equivalent substitutions or changes based on the technical solution and application concept of the present disclosure, and all these changes or substitutions should fall within the protection scope of the claims attached to the present disclosure.

1. An antenna device, comprising:
a printed circuit board (PCB), comprising a substrate layer and a metal layer stacked, wherein the metal layer comprises a first area and a second area, and the first area forms a radiator;
a metal plate, spaced apart from the PCB and located on one side of the substrate layer, wherein the metal plate forms a system ground and is electrically connected to the second area to ground the second area.

2. The antenna device according to claim 1, wherein the metal plate is electrically connected to the second area via a conductive member; the substrate layer is provided with a through hole, one end of the conductive member is connected to the metal plate, and the other end of the conductive member passes through the through hole and abuts against the second area.

3. The antenna device according to claim 1, wherein the metal plate is electrically connected to the second area through a conductive member; the substrate layer is provided with a via, a wall of the via is covered with a conductive layer, and the conductive member is connected to the second area through the via.

4. The antenna device according to claim 2, wherein the conductive member is a conductive foam, a metal spring or a metal ejector pin.

5. The antenna device according to claim 1, wherein the radiator comprises:
a first radiating portion, connected to a feed source to feed an excitation signal;
a second radiating portion, electromagnetically coupled to the first radiating portion.

6. The antenna device according to claim 5, wherein the first radiating portion comprises:
a low-frequency radiation branch, one end of low-frequency radiation branch being connected to the feed source, and the other end of low-frequency radiation branch forming a free end;
a first high-frequency radiation branch, one end of the first high-frequency radiation branch being connected to the low-frequency radiation branch, and the other end of the first high-frequency radiation branch being electrically connected to the second area to achieve grounding.

7. The antenna device according to claim 5, wherein the second radiation portion comprises a second high-frequency radiation branch, one end of the second high-frequency radiation branch is connected to the second area, and the other end of the second high-frequency radiation branch forms a free end.

8. The antenna device according to claim 6, wherein the low-frequency radiation branch comprises a first part and a second part, one end of the first part is used to connect to a feed source, and the other end of the first part is connected to the second part via a loading inductor.

9. The antenna device according to claim 8, wherein the second part is bent.

10. The antenna device according to claim 7, wherein a frequency range of the low-frequency radiation branch is 2.4 GHz to 2.5 GHZ;
a frequency range of the first high-frequency radiation branch and the second high-frequency radiation branch is 5.1 GHz to 5.9 GHZ.

11. The antenna device according to claim 10, further comprising a feed source disposed on the PCB and connected to the radiator through a microstrip line.

12. A screen projector, comprising:
a casing;
an antenna device, arranged in the casing and comprising:
a printed circuit board (PCB), comprising a substrate layer and a metal layer stacked, wherein the metal layer comprises a first area and a second area, and the first area forms a radiator; and
a metal plate, spaced apart from the PCB and located on one side of the substrate layer, wherein the metal plate forms a system ground and is electrically connected to the second area to ground the second area.

13. The screen projector according to claim 12, wherein the metal plate is electrically connected to the second area via a conductive member; the substrate layer is provided with a through hole, one end of the conductive member is connected to the metal plate, and the other end of the conductive member passes through the through hole and abuts against the second area.

14. The screen projector according to claim 12, wherein the metal plate is electrically connected to the second area through a conductive member; the substrate layer is provided with a via, a wall of the via is covered with a conductive layer, and the conductive member is connected to the second area through the via.

15. The screen projector according to claim 13, wherein the conductive member is a conductive foam, a metal spring or a metal ejector pin.

16. The screen projector according to claim 12, wherein the radiator comprises:
a first radiating portion, connected to a feed source to feed an excitation signal;
a second radiating portion, electromagnetically coupled to the first radiating portion.

17. A terminal device, comprising:
an antenna device, comprising;
a printed circuit board (PCB), comprising a substrate layer and a metal layer stacked, wherein the metal layer comprises a first area and a second area, and the first area forms a radiator; and
a metal plate, spaced apart from the PCB and located on one side of the substrate layer, wherein the metal plate forms a system ground and is electrically connected to the second area to ground the second area.

18. The terminal device according to claim 17, wherein the metal plate is electrically connected to the second area via a conductive member; the substrate layer is provided with a through hole, one end of the conductive member is connected to the metal plate, and the other end of the conductive member passes through the through hole and abuts against the second area.

19. The terminal device according to claim 17, wherein the metal plate is electrically connected to the second area through a conductive member; the substrate layer is provided with a via, a wall of the via is covered with a conductive layer, and the conductive member is connected to the second area through the via.

20. The terminal device according to claim 18, wherein the conductive member is a conductive foam, a metal spring or a metal ejector pin.
